(19) United States
(12) Patent Application Publication
(10) Pub. No.: US 2025/0371398 A1
(43) Pub. Date: Dec. 4, 2025

(54) BIAS-PRESERVING QUANTUM GATE FOR QUBIT

(71) Applicant: ANYON SYSTEMS INC., Dorval (CA)

(72) Inventor: Gabriel ETHIER-MAJCHER, Montreal (CA)

(21) Appl. No.: 18/875,903

(22) PCT Filed: Jun. 21, 2023
(86) PCT No.: PCT/CA2023/050860

§ 371 Date: Dec. 17, 2024

Related U.S. Application Data
(60) Provisional application No. 63/353,913, filed on Jun. 21, 2022.

(51) Int. Cl. G06N 10/40; G06N 10/70

(52) U.S. Cl. CPC G06N 10/40; G06N 10/70

(57) ABSTRACT

There is described herein a method and apparatus for applying a quantum gate to a protected qubit chain comprising an odd number of qubits of alternating orientation, the method comprising repeatedly isolating qubits from a first end of the chain and recoupling the isolated qubits to a second end of the chain until all qubits in the chain have been isolated and recoupled, wherein the recoupling changes an original orientation of the isolated qubits as the isolated qubits anti-align when re-coupling.

### CROSS-REFERENCE TO RELATED APPLICATIONS

The present application claims the benefit of U.S. Provisional Patent Application No. 63/353,913 filed on Jun. 21, 2022, the contents of which are hereby incorporated by reference.

### TECHNICAL FIELD

The present disclosure generally relates to quantum computing and more particularly, to quantum logic gates for performing operations on quantum bits.

### BACKGROUND OF THE ART

Quantum computers are machines that harness the properties of quantum states, such as superposition, interference, and entanglement, to perform computations. In a quantum computer, the basic unit of memory is a quantum bit, or qubit. A quantum computer with enough qubits has a computational power inaccessible to a classical computer, which is referred to as “quantum advantage”.

A significant challenge in quantum computation is the sensitivity of the quantum information to noise. The integrity of the quantum information is limited by the coherence time of the qubits and errors in the quantum gate operations, both of which are affected by the environmental noise. Therefore, improvements are needed.

### SUMMARY

In accordance with a first broad aspect, there is provided a method for applying a quantum gate to a protected qubit chain comprising an odd number of qubits of alternating orientation, the method comprising repeatedly isolating qubits from a first end of the chain and recoupling the isolated qubits to a second end of the chain until all qubits in the chain have been isolated and recoupled, wherein the recoupling changes an original orientation of the isolated qubits as the isolated qubits anti-align when recoupling.

In accordance with another broad aspect, there is provided an apparatus comprising quantum computing hardware in data communication with one or more classical processors, wherein the apparatus is configured to apply a quantum gate to a quantum circuit comprising a protected qubit chain, the protected qubit chain comprising an odd number of qubits of alternating orientation, wherein applying the quantum gate comprises repeatedly isolating qubits from a first end of the chain and recoupling the isolated qubits to a second end of the chain until all qubits in the chain have been isolated and recoupled, and wherein the recoupling changes an original orientation of the isolated qubits as the isolated qubits anti-align when recoupling.

In accordance with yet another broad aspect, there is provided a system comprising a processing device and a non-transitory computer-readable medium having stored thereon instructions for applying a quantum gate to a protected qubit chain comprising an odd number of qubits of alternating orientation. The instructions are executable by the processing device for repeatedly isolating qubits from a first end of the chain and recoupling the isolated qubits to a second end of the chain until all qubits in the chain have been isolated and recoupled, wherein the recoupling changes an original orientation of the isolated qubits as the isolated qubits anti-align when recoupling.

The method, apparatus, and system as defined above and described herein may further include one or more of the following features and/or elements, in whole or in part, and in any combination.

In certain aspects, the qubits are isolated and recoupled one at a time.

In certain aspects, isolating and recoupling the qubits comprises modulating control pulses applied to couplers interleaved between the qubits.

In certain aspects, applying the quantum gate further comprises initialising the qubit chain to a ground state prior to repeatedly isolating the qubits from the first end of the chain.

In certain aspects, the qubits are isolated adiabatically.

In certain aspects, the qubits are recoupled adiabatically.

In certain aspects, the qubits in the qubit chain are arranged in a ring formation.

In certain aspects, the qubits are superconducting qubits.

In certain aspects, the qubits are transmon qubits.

In certain aspects, the qubit chain comprises at least five qubits.

Many further features and combinations thereof concerning the present improvements will appear to those skilled in the art following a reading of the instant disclosure.

### BRIEF DESCRIPTION OF THE DRAWINGS

Reference is now made to the drawings, in which:

FIG. 1 is a block diagram of an example of a protected qubit chain;

FIG. 2 is an example implementation of the qubit chain of FIG. 1;

FIGS. 3A-3K are a schematic representation of a bias-preserving quantum gate;

FIGS. 4A-4B are graphical representations of applying the bias-preserving quantum gate to a five-qubit chain;

FIGS. 5A-5B are graphical representations of applying the bias-preserving quantum gate to a seven-qubit chain;

FIGS. 6A-6B are graphical representations of applying the bias-preserving quantum gate to an eleven-qubit chain;

FIGS. 7A-7B are graphical representations of applying the bias-preserving quantum gate to a six-qubit chain;

FIGS. 8A-8B are graphical representations of applying the bias-preserving quantum gate to an eleven-qubit chain with fluctuating control signals;

FIG. 9 is a flowchart of a method for applying a quantum gate to a topologically protected qubit chain;

FIG. 10 is a block diagram of a system for applying a quantum gate to a topologically protected qubit chain; and

FIG. 11 is a block diagram of an example embodiment of a quantum computing system.

### DETAILED DESCRIPTION

The present disclosure is directed to a bias-preserving quantum gate. The bias-preserving gate may be applied to any chain of two-state quantum-mechanical system, referred to herein as a quantum bit or qubit. The qubits may be superconducting qubits, spin qubits, quantum dot qubits, neutral-atom qubits, photonic qubits, and the like. In some embodiments, the qubit chain is a protected qubit chain. As used herein, the expression “protected” refers to an intrinsic protection against noise that causes decoherence of qubits. The qubit chain is engineered by coupling a number of physical qubits together to form a chain, to which we refer as a computational qubit. The chain can achieve a quantum state such that multiple physical qubits behave as a single computational qubit insensitive to certain types of noise and characterized by a longer lifetime or coherence time than the individual physical qubits. In this case, the computational qubit is said to operate in a protected regime.

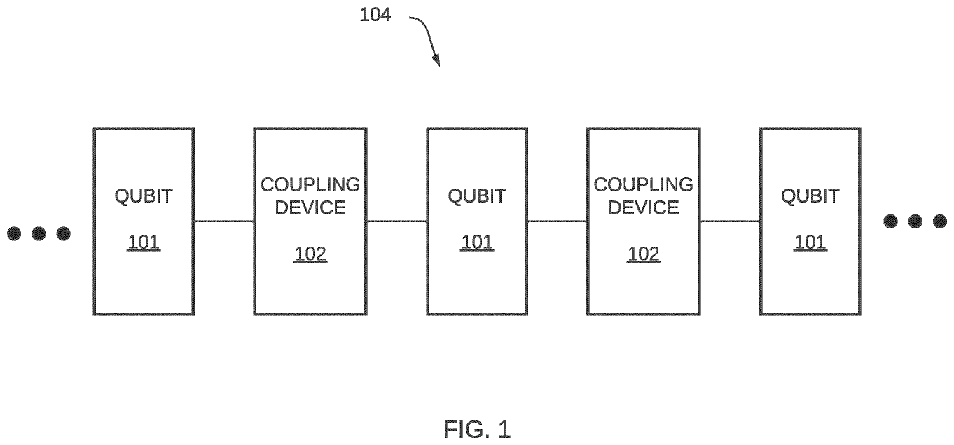

An example embodiment of a qubit chain is illustrated in FIG. 1. A plurality of physical qubits 101 are interleaved with a plurality of coupling devices 102 to form a circuit 104. In this example, the physical qubits 101 are superconducting qubits, and may be of different types, including charge qubits, flux qubits, phase qubits, and transmon qubits. In some embodiments, the circuit 104 forms part of a quantum processor.

The coupling between pairs of physical qubits 101 can be controlled by modulating control pulses, such as electric currents and/or voltages, applied to the qubits and/or coupling devices 102. The quantum states of the circuit 104 having N physical qubits 101 may be found from its Hamiltonian. Circuit 104 can be modeled as a 1D transversely coupled Ising spin chain, a system which, according to the Jordan-Wigner transformation, can emulate Majorana bound states. In the Ising spin chain model, the Hamiltonian of a chain of N coupled physical qubits is written as:

$${H}_{0} = - {Σ}_{i = 0}^{N - 1} h {σ}_{i}^{z} - {Σ}_{i = 0}^{N - 2} J {σ}_{i}^{x} {σ}_{i + 1}^{x} \qquad ( 1 )$$

The term o; is a Pauli operator on physical qubit i. The term h is the on-site energy of the physical qubits 101 and J represents the energy of the coupling between two physical qubits 101. The coupling is said to be of ferromagnetic type for J>0 such that the x components of the spins tend to align. The coupling is said to be of antiferromagnetic type for J<0 such that the x components of the spins anti-align. A phase transition from a non-protected regime to a protected regime occurs when the coupling energy becomes larger than the qubit energy. In other words, the condition for achieving protection is |J|>|h|. When this condition is met, we refer to the circuit 104 as having “deep strong coupling”. A circuit having deep strong coupling is said to operate in a protected regime.

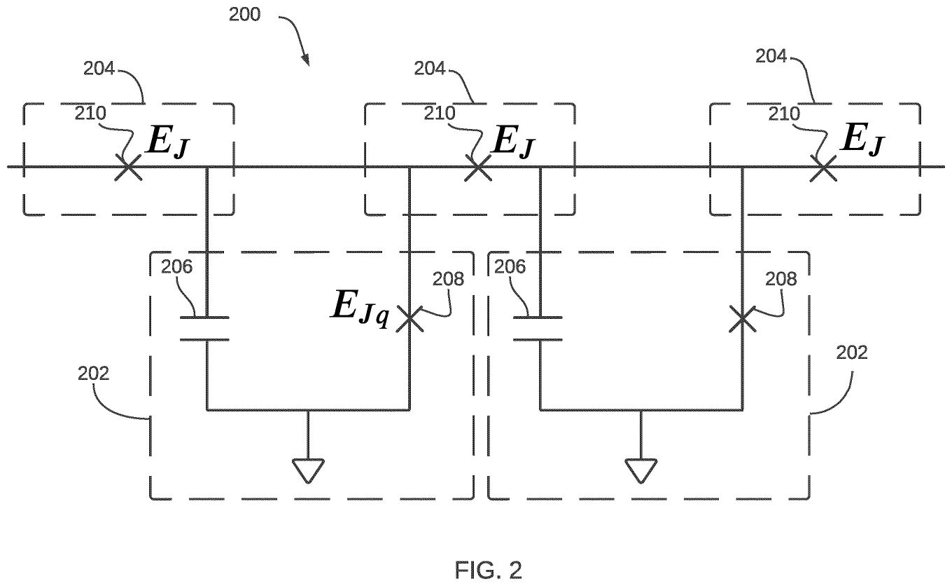

An example implementation of the circuit 104 is illustrated in FIG. 2. In this example, two physical qubits 202 are coupled to three coupling devices 204 to form a qubit chain 200. The physical qubits 202 are composed of at least one capacitor 206 and at least one Josephson junction 208 connected together, and may be, for example, transmon or charge qubits. Other architectures for the physical qubits 202 may also be used, such as but not limited to a differential architecture, a two-junction architecture, and an inductively shunted architecture. Each Josephson junction 208 may be replaced by a pair of Josephson junctions connected in parallel, referred to herein as a SQUID (superconducting quantum interference device), for tunability of the frequency of the respective physical qubits 202. Each coupling device 204 is composed of at least one Josephson junction 210.

In some embodiments, the Josephson junction 210 is a q-Josephson junction, for which the Josephson phase minimizing its potential energy is non-zero. In some embodiments, the Josephson junction 210 is a π-Josephson junction, and the Josephson phase minimizing its potential energy is π. In some embodiments, the Josephson junction is replaced with a SQUID, and the Josephson junctions forming the SQUID may be φ-Josephson junctions, π-Josephson junctions, or classical Josephson junctions (where the Josephson phase minimizing its potential energy is zero).

When the qubit chain 200 is in the protected regime, i.e. when |J|>|h| for all physical qubits 202 and couplers 204 in the chain 200, the chain 200 has two degenerate ground states which exponentially tend to the following states with the size of the chain:

$$\text{?} \qquad ( 2 )$$

$$\text{?}$$

$$\text{?} \text{indicates text missing or illegible when filed}$$

In eq. (2), |+ᵢ [symbol] , |−ᵢ [symbol] indicate that the i^{th} physical qubit is in the + or − eigenstate of the

$${σ}_{i}^{x}$$

operator, respectively. The physical qubits 202 are therefore oriented along the x-axis, either in the positive or negative direction. The orientation of the i^{th} physical qubit may be determined by the angles θ and ϕ defining the physical qubit state using:

$$\vert {ψ}_{i} 〉 = cos ( \frac{θ}{2} ) \vert {0}_{i} 〉 + {e}^{i ϕ} sin ( \frac{θ}{2} ) \vert {1}_{i} 〉 , \qquad ( 3 )$$

where |0ᵢ [symbol] and |1ᵢ [symbol] are the basis vectors of the i^{th} physical qubit. As an example, when θ=π and ϕ=0, the physical qubit orientation is positive along the x-axis. It will be understood that physical qubit orientation may also be along the y-axis, the z-axis, or any other arbitrary axis in a three-dimensional space. The degenerate ground states of the Ising chain present an antiferromagnetic order, meaning that the physical qubits are all aligned along the same axis, but with alternating directions. The physical qubits are thus in alternating orientations.

The two ground states have even or odd parity, with the parity operator defined as

$$P = {\prod }_{i = 0}^{N} {σ}_{i}^{z} .$$

The degenerate ground states are separated from all other states by an energy gap. This gap is key to the protection of the system against local noise. Indeed, the gap protects the system from non-parity breaking noise perturbations, such as

$${σ}_{i}^{y} and {σ}_{i}^{z} ,$$

as shown below:

$${σ}_{i}^{y} \vert + 〉 = - i \vert - 〉 ; {σ}_{i}^{y} \vert - 〉 = i \vert + 〉 \qquad ( 4 )$$

$${σ}_{i}^{z} \vert + 〉 = \vert - 〉 ; {σ}_{i}^{z} \vert - 〉 = \vert + 〉 \qquad ( 5 )$$

From eqs. (4) and (5), it can be seen that local noise operators

$${σ}_{i}^{y} and {σ}_{i}^{z}$$

can bring the qubit chain out of the ground state by flipping a single qubit but cannot couple the degenerate states to one another. Given the large energy difference between the degenerate ground states and the excited states of the chain, such a jump is unlikely, and the energy gap protects the chain from

$${σ}_{i}^{y} and {σ}_{i}^{z}$$

noise

The system is however vulnerable to parity breaking noise such as

$${σ}_{i}^{x} .$$

The system is thus noise-biased. There exist computational states which are linear combinations of the degenerate ground states from eq. (2), and for which

$${σ}_{i}^{x} .$$

perturbations will only lead to phase-flips, such that the computational states are protected against bit-flips. These states are given by:

$$\text{?} \qquad ( 6 )$$

$$\text{?}$$

$$\text{?} \text{indicates text missing or illegible when filed}$$

In such a case, the effect of local noise operator of on the computational states in (6) are shown below:

$${σ}_{i}^{x} \vert + 〉 = \vert + 〉 ; {σ}_{i}^{x} \vert - 〉 = - \vert - 〉 \qquad ( 7 )$$

The computational states in eq. (6) may thus be used as a basis for encoding quantum information, such that the circuit is protected against bit-flips. It will be understood that the computational states may also be defined as any other linear combination of the degenerate ground states of eq. (2). In particular, computational states may be chosen such that the system is protected against phase-flips and vulnerable to bit-flips. Either definition may be used herein.

Operations are performed on qubits (physical or computational) by applying quantum logic gates, which are basic quantum circuits operating on a small number of qubits. Some of the most common and useful quantum gates are the Pauli gates (X, Y, Z). Each Pauli gate is a rotation around the x, y, and z axes, respectively, of a Bloch sphere, which is a geometrical representation of the quantum state space of a two-level quantum mechanical system. The Pauli-X gate is the quantum equivalent of a NOT gate for classical computers with respect to the standard basis states |0 [symbol] and |1 [symbol] . The Pauli-X gate is sometimes called a bit-flip as it maps |0 [symbol] to |1 [symbol] and |1 [symbol] to |0 [symbol] . Similarly, the Pauli-Y maps |0 [symbol] to i|1 [symbol] and |1 [symbol] to −i|0 [symbol] . Pauli-Z leaves the basis state |0 [symbol] unchanged and maps |1 [symbol] to −|1 [symbol] . Due to this nature, Pauli-Z is sometimes called a phase-flip.

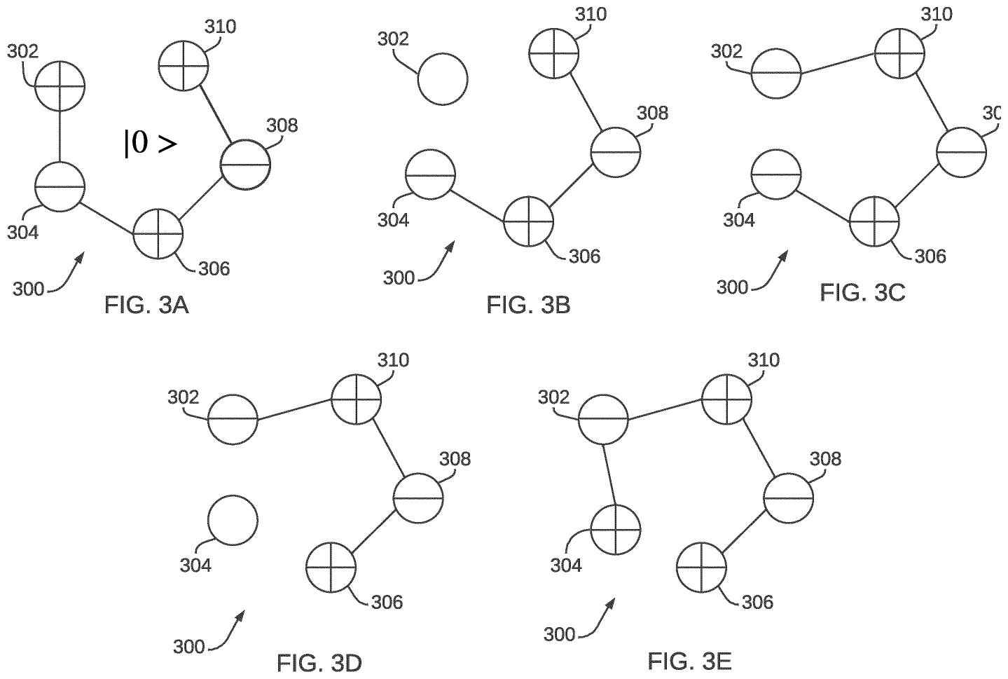

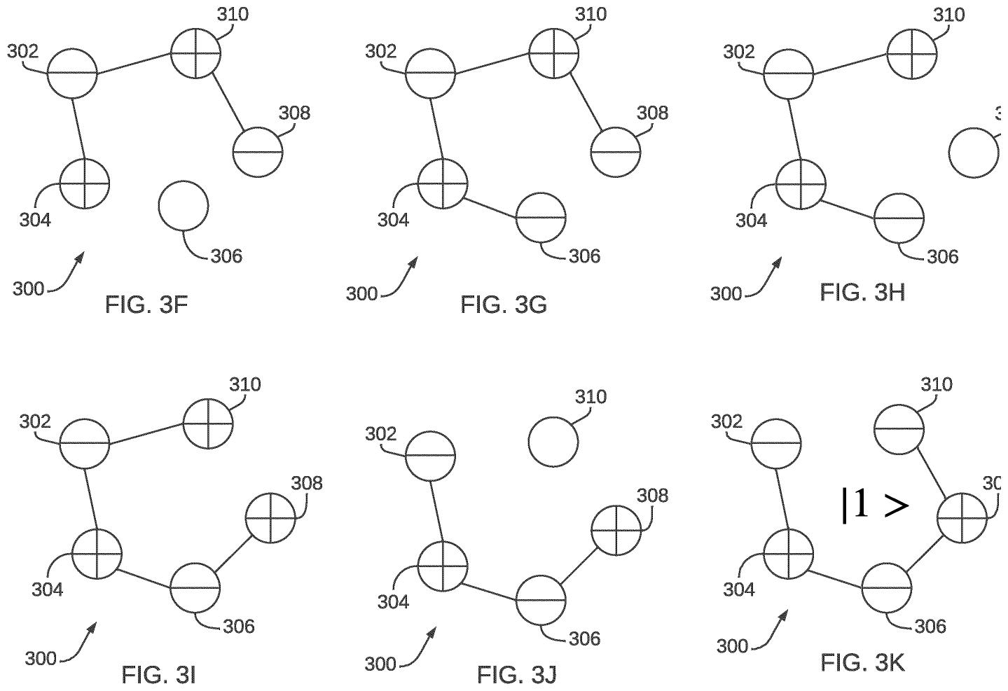

In order to apply a quantum gate while preserving the noise-bias of the qubit chain 200, a non-local operation is performed. Physical qubits 202 are repeatedly decoupled from one end of the chain 200 and recoupled to the other end of the chain 200, thus causing a change in their orientation as the qubits anti-align when recoupled. The gating process is schematically illustrated in FIGS. 3A-3K. FIG. 3A shows an odd number of physical qubits 302, 304, 306, 308, 310, namely five in this example, forming a chain 300. The chain 300, or computational qubit, is initially provided in a first ground state of |0 [symbol] with alternating positive and negative orientations. In some embodiments, the physical qubits are arranged in a ring formation. Other arrangements may also be used. Physical qubits having a positive orientation along the x-axis are illustrated with a “+”, physical qubits having a negative orientation along the x-axis are illustrated with a “−”. When the chain is idling (i.e. no operation is performed), physical qubit 302 is coupled to physical qubit 304, which is coupled to physical qubit 306, which is coupled to physical qubit 308, which is coupled to physical qubit 310. Physical qubits 302 and 310 are the end qubits of the chain 300 and are therefore decoupled prior to performing the gate.

In FIG. 3B, a physical qubit from one end of the chain 300, such as physical qubit 302, is isolated from the chain 300 by uncoupling physical qubit 302 from its neighbor, physical qubit 304. An isolated (or decoupled) physical qubit is illustrated as empty. In FIG. 3C, physical qubit 302 is coupled to the other end of the chain 300, namely to physical qubit 310, causing physical qubit 302 to anti-align with physical qubit 310 and thus resulting in a change in orientation from positive to negative. At this stage, physical qubits 302 and 304 are the end qubits of the chain 300.

The process of uncoupling an end qubit from the chain 300 and recoupling it to the other end of the chain 300 is repeated sequentially for the remaining physical qubits in the chain 300. At FIG. 3D, physical qubit 304 is decoupled from its neighbor, physical qubit 306, and thus isolated from the chain 300. At FIG. 3E, physical qubit 304 is coupled to the other end of the chain 300 to physical qubit 302, to which it anti-aligns to a positive orientation. At this stage, physical qubits 304 and 306 are the end qubits of the chain 300. At FIG. 3F, physical qubit 306 is decoupled from its neighbor, physical qubit 308, and thus isolated from the chain 300. At FIG. 3G, physical qubit 306 is coupled to the other end of the chain 300 to physical qubit 304, to which it anti-aligns to a negative orientation. At this stage, physical qubits 306 and 308 are the end qubits of the chain 300. At FIG. 3H, physical qubit 308 is decoupled from its neighbor, physical qubit 310, and thus isolated from the chain 300. At FIG. 3I, physical qubit 308 is coupled to the other end of the chain 300 to physical qubit 306, to which it anti-aligns to a positive orientation. At this stage physical qubits 308 and 310 are the end qubits of the chain 300. At FIG. 3J, the last physical qubit of the chain 300, namely physical qubit 310, is decoupled from its neighbor, physical qubit 302, and thus isolated from the chain 300. At FIG. 3K, physical qubit 310 is coupled to the other end of the chain 300 to physical qubit 308, to which it anti-aligns to a negative orientation. At this stage, physical qubits 302 and 310 are the end qubits of the chain 300, as they were in the initial computational state |0 [symbol] (FIG. 3A). Furthermore, every physical qubit 302, 304, 306, 308, 310 has changed its orientation from the first computational state |0 [symbol] shown in FIG. 3A to the second computational state |1 [symbol] . Since the symmetry of the Hamiltonian of the chain 300 is never changed during the application of the gate (the chain 300 is simply rotated in time), the process is bias-preserving. It will be understood that the nature of the gate, i.e., whether the gate is a bit-flip or a phase-flip, may change depending on how the computational states of the computational qubit are defined.

In the example of FIGS. 3A-3K, the process is started with qubit 302 but it could also be started with qubit 310. In this case, the sequence of physical qubits to be decoupled from one end of the chain 300 and recoupled to the other end of the chain 300 would be qubit 310, qubit 308, qubit 306, qubit 304, and qubit 302. The sequence begins with a physical qubit at one end of the chain 300 and continues with the physical qubit from which the previous physical qubit was decoupled, which has become an end qubit after the previous physical qubit is recoupled to the other end of the chain 300. In some embodiments, two or more physical qubits are isolated and recoupled at a time. That is to say, each step in the sequence illustrated in FIGS. 3A-3K may involve two neighboring qubits, three neighboring qubits, or more. For example, qubits 302 and 304 may both be isolated from one end of the chain 300 concurrently, as well as from each other. Qubits 302 and 304 are then recoupled together and to the other end of the chain 300, i.e., to qubit 310, concurrently.

The process described herein can be represented mathematically with the total Hamiltonian H=H₀+H_{g}(t), where Ho is the static Ising Hamiltonian given by eq. (1) and H_{g}(t) is the gate Hamiltonian as follows:

$${H}_{g} ( t ) = - {Σ}_{i = 0}^{N - 2} Δ {J}_{i} ( t ) {σ}_{i}^{x} {σ}_{i + 1}^{x} - Δ {J}_{N - 1} ( t ) {σ}_{N - 1}^{x} {σ}_{0}^{x} \qquad ( 8 )$$

where ΔJᵢ(t) is the time-dependent change of the i^{th} coupling energy and ΔJ_{N-1}(t) is the time-dependent change of the coupling energy between the two ends of the Ising chain.

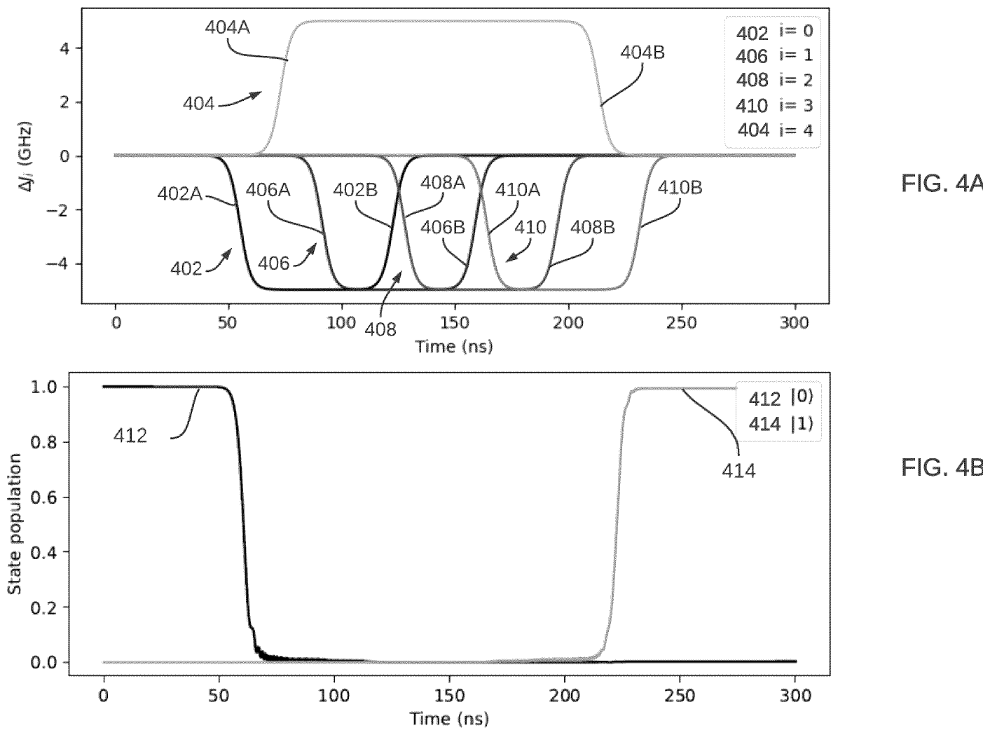

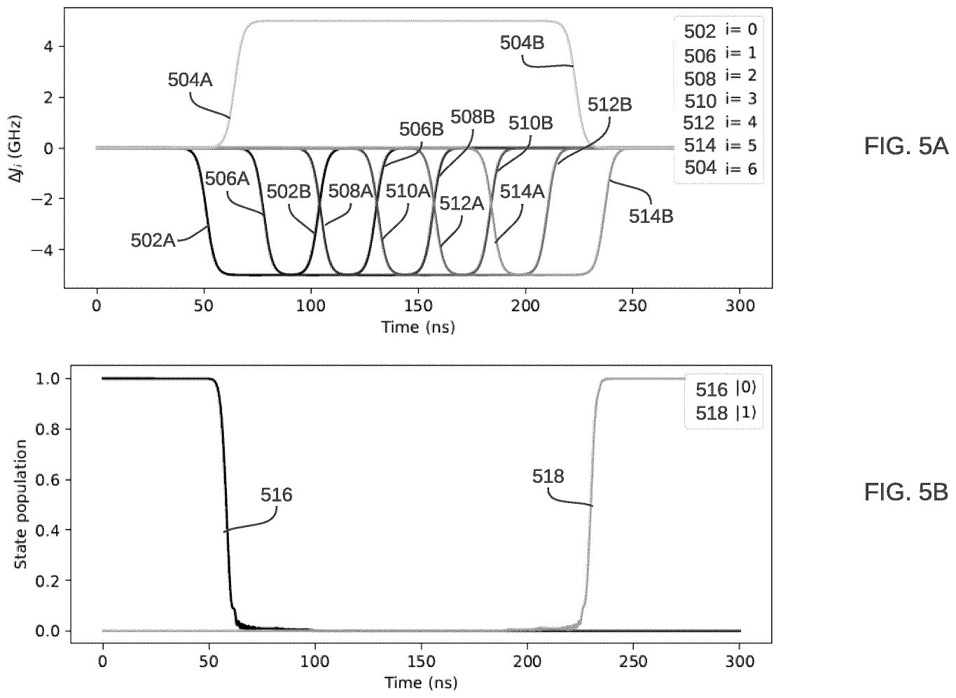

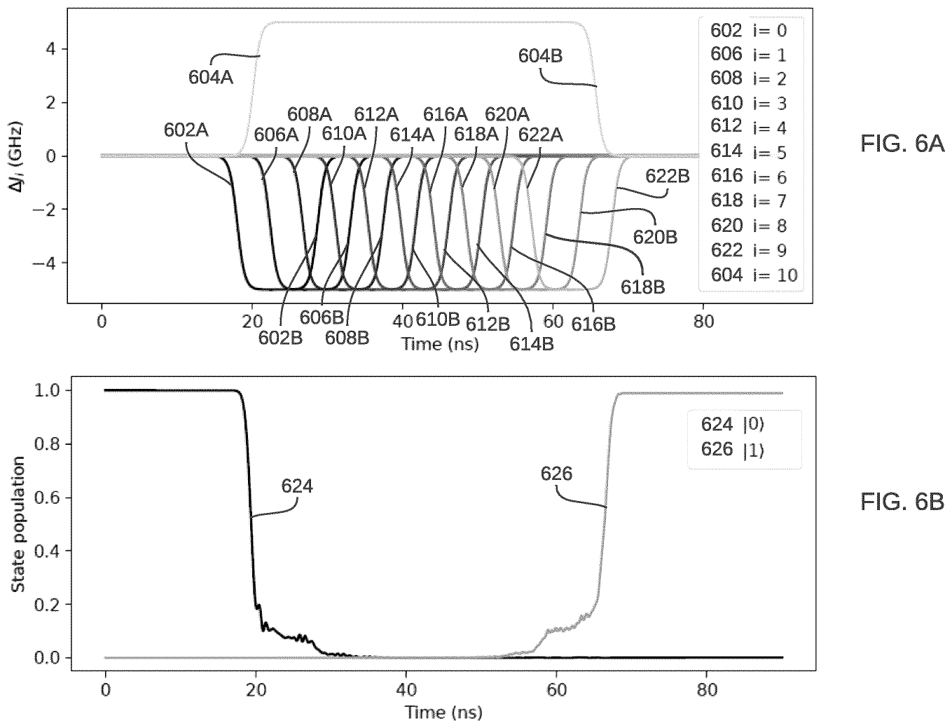

FIGS. 4A-4B illustrate graphically an example embodiment of the bias-preserving gate as applied to a chain of 5 physical qubits, with J=5 GHz and h=0.5 GHZ, and with a gate duration of 200 ns. FIGS. 5A-5B illustrate graphically an example embodiment of the bias-preserving gate as applied to a chain of 7 qubits, with J=5 GHz and h=0.5 GHZ, and a gate duration of 200 ns. FIGS. 6A-6B illustrate graphically an example embodiment of the bias-preserving gate as applied to a chain of 11 qubits, with J=5 GHZ and h=2 GHz, with a gate duration of 50 ns. These parameters are merely used for illustrative purposes and should not be viewed as limiting.

FIGS. 4A, 5A and 6A illustrate the control signals applied to the couplers of the chain 300 as each qubit is isolated and connected to an opposite end of the chain 300. In FIG. 4A, five control signals are shown. Signal 402 decouples and couples qubit 302 from qubit 304. Portion 402A of signal 402 decouples qubit 302 from qubit 304 (FIG. 3B). Portion 402B of signal 402 couples qubit 304 to qubit 302 (FIG. 3E). Signal 404 couples and decouples qubit 310 from qubit 302. Portion 404A of signal 404 couples qubit 302 to qubit 310 (FIG. 3C). Portion 404B of signal 404 decouples qubit 310 from qubit 302 (FIG. 3J). Signal 406 decouples and couples qubit 304 from qubit 306. Portion 406A of signal 406 decouples qubit 304 from qubit 306 (FIG. 3D). Portion 406B of signal 406 couples qubit 306 to qubit 304 (FIG. 3G). Signal 408 decouples and couples qubit 306 from qubit 308. Portion 408A of signal 408 decouples qubit 306 from qubit 308 (FIG. 3F). Portion 408B of signal 408 couples qubit 308 to qubit 306 (FIG. 3I). Signal 410 decouples and couples qubit 308 from qubit 310. Portion 410A of signal 410 decouples qubit 308 from qubit 310 (FIG. 3H). Portion 410B of signal 410 couples qubit 310 to qubit 308 (FIG. 3K).

Seven control signals are shown in FIG. 5A in order to apply the bias-preserving gate to a chain of 7 qubits. For illustrative purposes, the chain of 7 qubits has qubits 1-7 initially connected in the following sequence: qubit_1, qubit_2, qubit_3, qubit_4, qubit_5, qubit_6, qubit_7. Qubit_1 and qubit_7 are the ends of the chain. The signal 502 decouples and couples qubit_1 from qubit_2. Portion 502A of signal 502 decouples qubit_1 from qubit 2. Portion 502B of signal 502 couples qubit_2 to qubit_1. Signal 504 couples and decouples qubit_7 from qubit_1. Portion 504A of signal 504 couples qubit_1 to qubit_7. Portion 404B of signal 404 decouples qubit_1 from qubit_7. Signal 506 decouples and couples qubit_2 from qubit_3. Portion 506A of signal 506 decouples qubit_2 from qubit_3. Portion 506B of signal 506 couples qubit_2 to qubit_3. Signal 508 decouples and couples qubit_3 from qubit_4. Portion 508A of signal 508 decouples qubit_3 from qubit_4. Portion 508B of signal 508 couples qubit_4 to qubit_3. Signal 510 decouples and couples qubit_4 from qubit_5. Portion 510A of signal 510 decouples qubit_4 from qubit_5. Portion 510B of signal 510 couples qubit_5 to qubit_4. Signal 512 decouples and couples qubit_5 from qubit_6. Portion 512A of signal 512 decouples qubit_5 from qubit_6. Portion 512B of signal 512 couples qubit_6 to qubit_5. Signal 514 decouples and couples qubit_6 from qubit_7. Portion 514A of signal 514 decouples qubit_6 from qubit_7. Portion 514B couples qubit_7 to qubit_6.

Eleven control signals are shown in FIG. 6A in order to apply the bias-preserving gate to a chain of 11 qubits. Signals 602, 604, 606, 608, 610, 612, 614, 616, 618, 620, 622 are applied to the 11-qubit chain in a manner similar as that described above with respect to the 5-qubit chain and the 7-qubit chain. Decreasing signal portions 602A, 604B, 606A, 608A, 610A, 612A, 614A, 616A, 618A, 620A, 622A decouple a given qubit from the chain of qubits, increasing signal portions 602B, 604A, 606B, 608B, 610B, 612B, 614B, 616B, 618B, 620B, 622B couple an isolated qubit to the chain of qubits.

FIGS. 4B, 5B and 6B illustrate the population states |0 [symbol] , |1 [symbol] as a function of time. The population is shown to be flipped from states |0 [symbol] to |1 [symbol] under the gate Hamiltonian. In FIG. 4B, signal 412 illustrates the computational state |0 [symbol] prior to the gate operation, signal 414 illustrate the computational state |1 [symbol] after the gate operation. In FIG. 5B, signal 516 illustrates the computational state |0 [symbol] prior to the gate operation, signal 518 illustrates the computational state |1 [symbol] after the gate operation. In FIG. 6B, signal 624 illustrates the computational state |0 [symbol] prior to the gate operation, signal 626 illustrates the computational state |1 [symbol] after the gate operation.

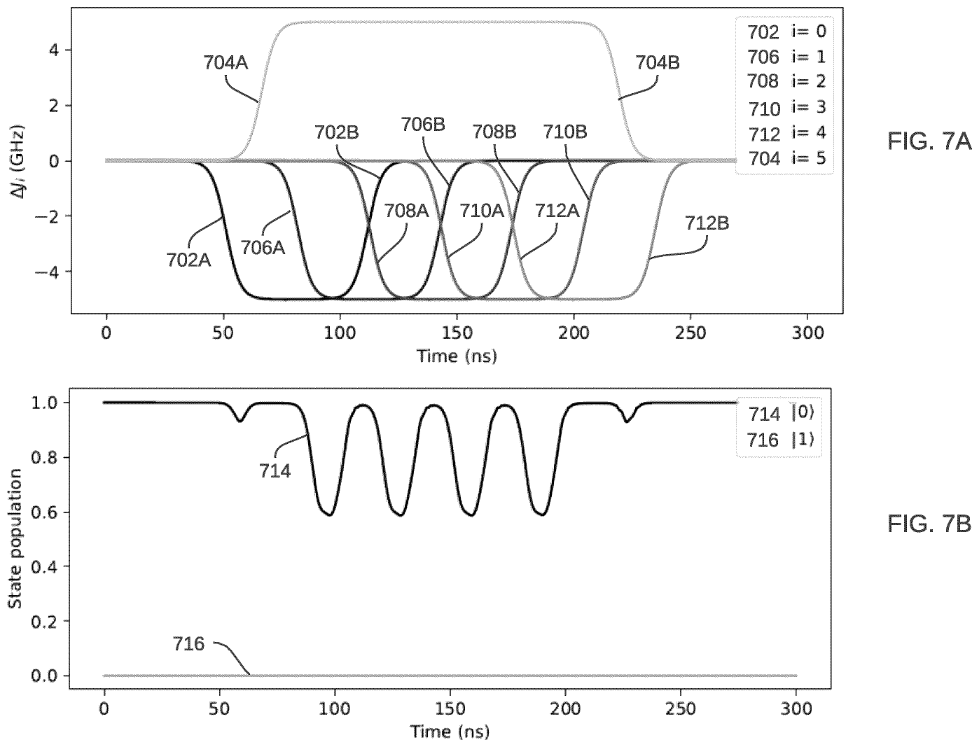

The bias-preserving gate can be applied to any qubit chain having an odd number of physical qubits, as shown in the examples of FIGS. 4-6. FIGS. 7A-7B illustrate graphically the bias-preserving gate as applied to a chain having an even number of physical qubits, namely six, with J=5 GHz and h=0.5 GHz, and a gate duration of 200 ns. If the chain has an even number of physical qubits, the two end qubits of the chain are of a different orientation since half the physical qubits initially have a positive orientation and half of the physical qubits initially have a negative orientation. Decoupling the first end qubit from one end of the chain and coupling it to the physical qubit at the other end of the chain does not cause a change in orientation in the isolated and recoupled physical qubit. The recoupled physical qubit would simply regain its original orientation as its original orientation was already opposite to the orientation of the other end qubit. FIG. 7A shows the control signals 702, 704, 706, 708, 710, 712 for sequentially decoupling an end qubit from the chain and recoupling the isolated qubit to the other end of the chain. Decreasing signal portions 702A, 704B, 706A, 708A, 710A, 712A decouple a given qubit from the chain of qubits, increasing signal portions 702B, 704A, 706B, 708B, 710B, 712B couple an isolated qubit to the chain of qubits. As shown in FIG. 7B, the chain remains in the ground state |0 [symbol] after the gate has been applied. Signal 714 illustrates the computational state |0 [symbol] prior to the gate operation, signal 716 illustrates the computational state |1 [symbol] after the gate operation.

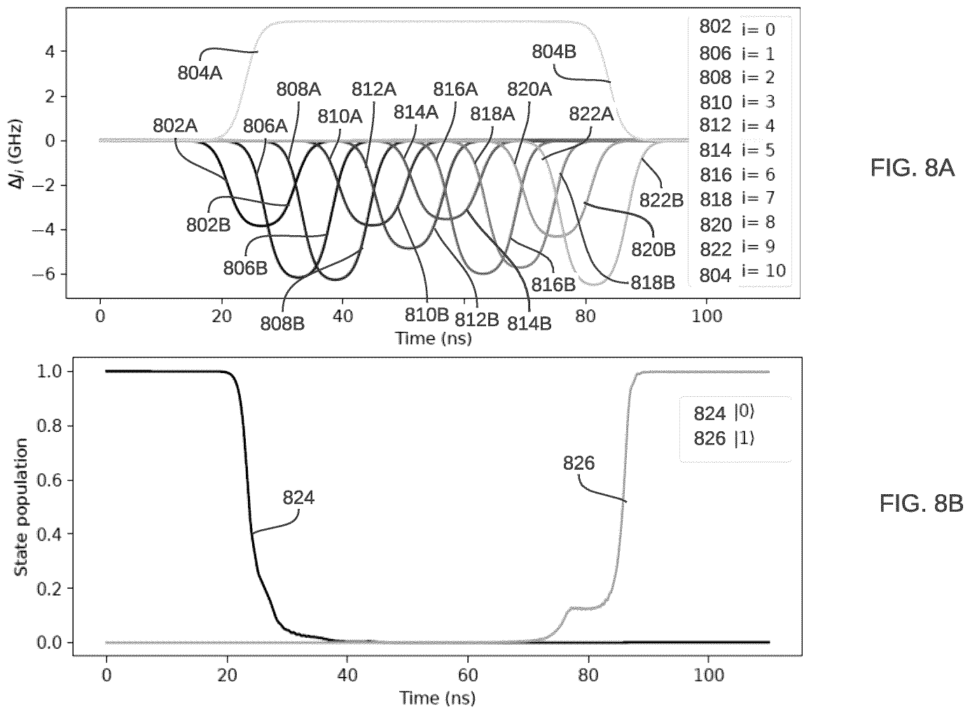

FIGS. 8A-8B demonstrate the robustness of the bias-preserving gate to noise in the control signals, as applied to a chain having 11 qubits, with J=5 GHz and h=0.5 GHZ, and a gate duration of 70 ns. In FIG. 8A, variations of up to 40% are applied to the gate control signals 802, 804, 806, 808, 810, 812, 814, 816, 818, 820, 822. Decreasing signal portions 802A, 804B, 806A, 808A, 810A, 812A, 814A, 816A, 818A, 820A, 822A decouple a given qubit from the chain of qubits, increasing signal portions 802B, 804A, 806B, 808B, 810B, 812B, 814B, 816B, 818B, 820B, 822B couple an isolated qubit to the chain of qubits. In FIG. 8B, the final qubit state is shown to be unaffected by the fluctuations in the control signals. Signal 824 illustrates the computational state |0 [symbol] prior to the gate operation, signal 826 illustrates the computational state |1 [symbol] after the gate operation. The bias-preserving quantum gate is thus resilient to noise in the control signals.

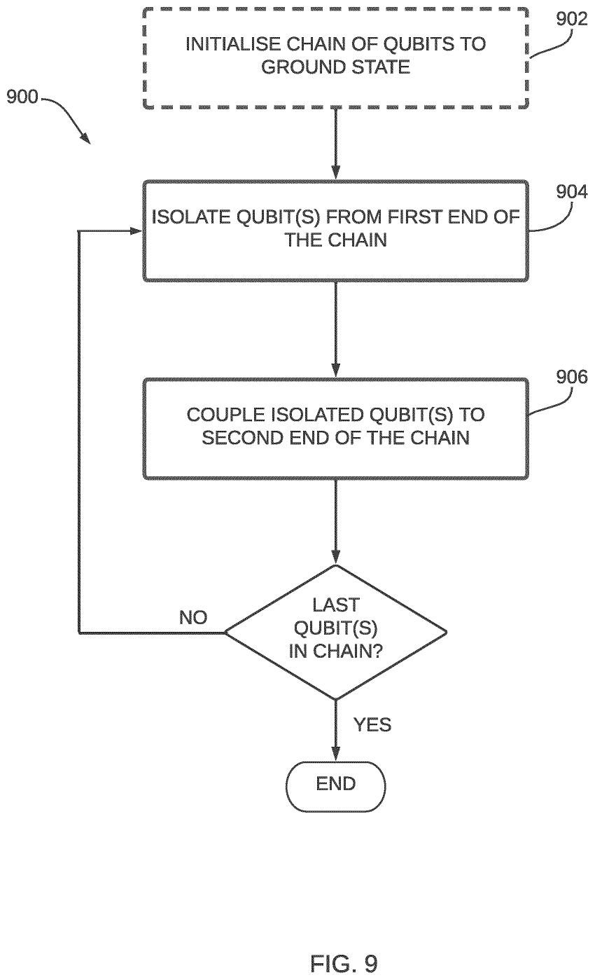

With respect to FIG. 9, there is illustrated a method 900 for performing a bias-preserving quantum gate on a protected qubit chain, the chain comprising an odd number of physical qubits of alternating orientation. If the chain of physical qubits is not yet in one of the degenerate ground states or a linear combination thereof, it may be initialised to a ground state at step 902. If the chain of physical qubits is already in a ground state, step 902 may be omitted. At step 904, one or more physical qubits from a first end of the chain are isolated from the chain. At step 906, the one or more isolated physical qubits are coupled to the second end of the chain. Steps 904 and 906 are repeated until all physical qubits in the chain have been isolated and subsequently coupled. In some embodiments, each physical qubit is isolated and recoupled sequentially. In some embodiments, two or more physical qubits are isolated and recoupled concurrently, which can speed up the gate and still allow the qubit chain's protected state to be maintained if the chain is long enough.

In some embodiments, the physical qubits are coupled and/or decoupled adiabatically. This allows the chain to remain in its ground state during the gating process, and the isolated physical qubit(s) also remain in their isolated ground state. When coupling an isolated physical qubit to the other end of the chain, the physical qubits anti-align to maintain the ground state for the chain. When trying to operate fast gates, having a larger qubit energy h can be helpful to ensure that the adiabatic condition is maintained when isolating a single physical qubit. When the number of physical qubits in the chain is larger, a smaller [symbol] ratio can be tolerated while still maintaining quasi-degenerate ground states in the protected regime.

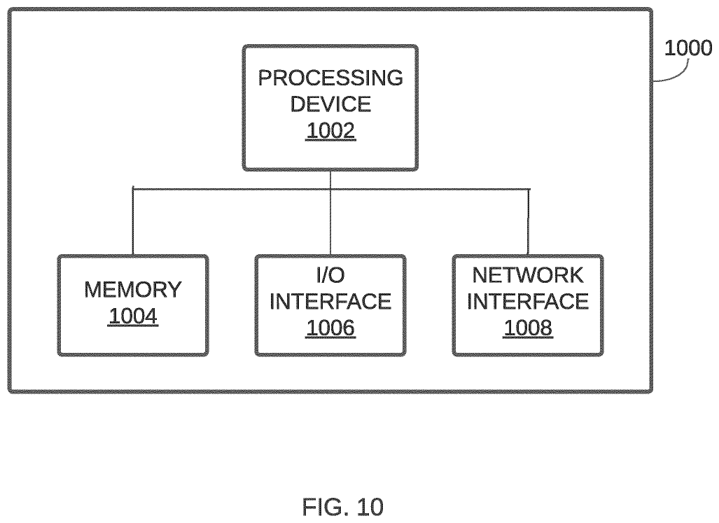

In some embodiments, the method 900 is embodied as a set of instructions stored on a non-transitory computer-readable medium. The instructions are executable by a processing device for performing the bias-preserving quantum gate. FIG. 10 is an example system 1000 for implementing the method 900 in accordance with various embodiments. The system 1000 can be provided as part of a classical computer that interfaces with a quantum processor. The system 1000 can also be provided as a set of control electronics that interface with a quantum processor.

As depicted, the system 1000 can include one or more of a processing device 1002, a memory 1004, an input/output (I/O) interface 1006, and a network interface 1008. The processing device(s) 1002 may be an Intel or AMD x86 or x64, PowerPC, ARM processor, or the like. In some embodiments, the processing device(s) 1002 is a field programmable gate array (FPGA) or an application specific integrated circuit (ASIC), provided on one or more board. Each memory 1004 may include a suitable combination of computer memory that is located either internally or externally such as, for example, random-access memory (RAM), read-only memory (ROM), integrated memory, compact disc read-only memory (CDROM). In some embodiments, both an on-board high bandwidth memory and an off-board memory are provided.

Each I/O interface 1006 enables the system 1000 to interconnect with one or more other devices, such as a host computer, a network switch, and the like. The I/O interface 1006 can be used, for example, for receiving instructions for the processing device 1002. Various communication protocols may be used for communicating with the system 1000 through the I/O interface 1006, such as but not limited to Peripheral Component Interconnect Express (PCIe), Ethernet, InfiniBand, and the like.

Each network interface 1008 enables the system 1000 to communicate with other components, for example, through an API to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others.

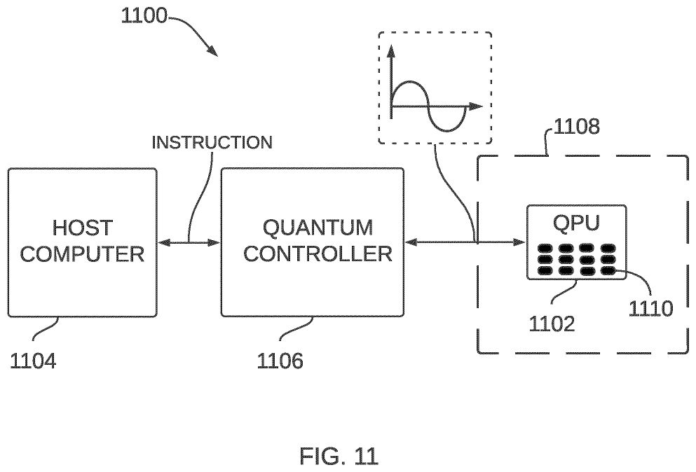

The bias-preserving gate as described herein may be implemented in a quantum computing system. An example architecture of a quantum computing system 1100 is illustrated in FIG. 11. The system 1100 includes a quantum processor 1102, a host computer 1104, and a quantum controller 1106 coupled therebetween. The quantum processor 1102 comprises a plurality of qubits 1110. Any number of qubits 1110 may be provided in the quantum processor 1102, from just a few qubits 1110, to tens of qubits 1110, to hundreds of qubits 1110, to thousands of qubits 1110, to millions of qubits 1110. In some embodiments, the quantum processor 1102 is located in a cryogenic environment 1108, such as a dilution refrigerator. Dilution refrigerators are cryogenic devices that provide continuous cooling in a cryostat from ambient temperature all the way down to millikelvin temperatures without any moving part at the low temperature stages (below 3 K). The cryostat consists of one or more vacuum enclosure with cold flanges that progressively reach low temperatures for the operation of the quantum processor 1102.

The quantum controller 1106 consists of dedicated hardware for controlling and operating the qubits 1110 in the quantum processor 1102. Although illustrated as separate from the cryogenic environment 1108, one or more component of the quantum controller 1106 may reside inside the cryogenic environment 1108, such as inside the cryostat. The one or more component of the quantum controller 1106 inside the cryogenic environment 1108 may be held at the same temperature as the quantum processor 1102 or at a higher temperature, as appropriate. In some embodiments, one or more component of the quantum controller 1106 is held at the same temperature as the quantum processor 1102 and one or more component of the quantum controller 1106 is held at a higher temperature than the quantum processor 1102 inside the cryogenic environment 1108.

One or more component of the quantum controller 1106 may be configured to perform the method 900. For example, the method 900 may be implemented by programmable logic comprising one or more circuit that can be configured to implement logic functions using logic elements and a hierarchy of interconnects that may or may not be reconfigurable. the programmable logic may comprise one or more Programmable Logic Device (PLD), such as Programmable Read Only Memory (PROM), Programmable Array Logic (PAL), and Programmable Logic Array (PLA). In some embodiments, the programmable logic comprises one or more Application-Specific Integrated Circuit (ASIC). In some embodiments, the programmable logic comprises one or more Complex Programmable Logic Device (CPLD). In some embodiments, the programmable logic comprises one or more Field Programmable Gate Array (FPGA).

The quantum controller 1106 is coupled to one or more host computer 1104, which acts as the interface between the outside world and the quantum computing system 1100. Although a single host computer 1104 is illustrated, it will be understood that there may a plurality of host computers 1104 connected to the quantum controller 1106. The host computer 1104 may be a classical computer, used to access the quantum computing system 1100 and more specifically, to create and run quantum algorithms on the quantum computing system 1100. The quantum controller 1106 receives instructions from the host computer 1104 and converts the instructions into waveforms that are readable by the quantum processor 1102. The instructions may relate to various types of operations performed on the quantum processor 1102, such as gating operations, calibration operations, tuning operations, and measurement operations. The bias-preserving gate described herein may be one such gating operation performed on the quantum processor 1102. In some embodiments, the system 1000 of FIG. 10 corresponds to the host computer 1104.

The described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions, and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufactures, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufactures, compositions of matter, means, methods, or steps. As can be understood, the examples described above and illustrated are intended to be exemplary only.

1. A method for applying a quantum gate to a protected qubit chain comprising an odd number of qubits of alternating orientation, the method comprising repeatedly isolating qubits from a first end of the chain and recoupling the isolated qubits to a second end of the chain until all qubits in the chain have been isolated and recoupled, wherein the recoupling changes an original orientation of the isolated qubits as the isolated qubits anti-align when recoupling.

2. The method of claim 1, wherein the qubits are isolated and recoupled one at a time.

3. The method of claim 1, wherein isolating and recoupling the qubits comprises modulating control pulses applied to couplers interleaved between the qubits.

4. The method of claim 1, further comprising initialising the qubit chain to a ground state prior to repeatedly isolating the qubits from the first end of the chain.

5. The method of claim 1, wherein the qubits are isolated adiabatically.

6. The method of claim 1, wherein the qubits are recoupled adiabatically.

7. The method of claim 1, wherein the qubits in the qubit chain are arranged in a ring formation.

8. The method of claim 1, wherein the qubits are superconducting qubits.

9. The method of claim 1, wherein the qubits are transmon qubits.

10. The method of claim 1, wherein the qubit chain comprises at least five qubits.

11. An apparatus comprising quantum computing hardware in data communication with one or more classical processors, wherein the apparatus is configured to apply a quantum gate to a quantum circuit comprising a protected qubit chain, the protected qubit chain comprising an odd number of qubits of alternating orientation, wherein applying the quantum gate comprises repeatedly isolating qubits from a first end of the chain and recoupling the isolated qubits to a second end of the chain until all qubits in the chain have been isolated and recoupled, and wherein the recoupling changes an original orientation of the isolated qubits as the isolated qubits anti-align when recoupling.

12. The apparatus of claim 11, wherein the qubits are isolated and recoupled one at a time.

13. The apparatus of claim 11, wherein isolating and recoupling the qubits comprises modulating control pulses applied to couplers interleaved between the qubits.

14. The apparatus of claim 11, wherein applying the quantum gate further comprises initialising the qubit chain to a ground state prior to repeatedly isolating the qubits from the first end of the chain.

15. The apparatus of claim 11, wherein the qubits are isolated adiabatically.

16. The apparatus of claim 11, wherein the qubits are recoupled adiabatically.

17. The apparatus of claim 11, wherein the qubits in the qubit chain are arranged in a ring formation.

18. The apparatus of claim 11, wherein the qubits are superconducting qubits.

19. The apparatus of claim 11, wherein the qubits are transmon qubits.

20. The apparatus of claim 11, wherein the qubit chain comprises at least five qubits.
